(19) United States
(12) Patent Application Publication
(10) Pub. No.: US 2026/0099707 A1
(43) Pub. Date: Apr. 9, 2026

(54) SAFETY ALIGNMENT FOR LANGUAGE MODELS BASED ON LANGUAGE MODEL-GENERATED SAFETY CATEGORIES

(71) Applicant: NVIDIA Corporation, Santa Clara, CA (US)

(72) Inventors: Shaona GHOSH, Campbell, CA (US); Prasoon Varshney, Santa Clara, CA (US); Makesn Narsimhan Sreedhar, Santa Clara, CA (US); Aishwarya Padmakumar, Sunnyvale, CA (US); Traian Eugen Rebedea, Bucharest (RO); Christopher Marc Rarisien, Toronto, CA (US)

(21) Appl. No.: 19/331,849

(22) Filed: Sep. 17, 2025

Related U.S. Application Data
(60) Provisional application No. 63/702,595, filed on Oct. 2, 2024.

(51) Int. Cl. G06N 3/08; G06N 20/20

(52) U.S. Cl. CPC G06N 3/08; G06N 20/20

(57) ABSTRACT

In various examples, techniques for training a language model to implement guardrails on generated outputs include receiving a data set including a plurality of interactions with a language model, each interaction of the plurality of interactions being associated with a predefined safety label; generating, using an ensemble of generative artificial intelligence models, one or more machine-defined safety labels for each interaction in the plurality of interactions; generating a training data set based on revising a label associated with each interaction of the plurality of interactions, the revising being based on a majority vote of the one or more machine-defined safety labels and the predefined safety label associated with each interaction of the plurality of interactions; and training the language model based on the training data set, wherein the training implements guardrails on an output of the language model such that the language model is restricted from generating responses including unsafe content.

### CROSS-REFERENCE TO RELATED APPLICATIONS

This application claims priority to and benefit of U.S. Provisional Patent Application Ser. No. 63/702,595, entitled “Safe Dataset Creation with Human-LLM Jury Evaluations,” filed Oct. 2, 2024, and assigned to the assignee hereof, the entire contents of which are hereby incorporated by reference.

### TECHNICAL FIELD

Embodiments of the present disclosure relate generally to generative artificial intelligence models, and more specifically to model safety alignment for language models based on language model-generated safety categories.

### BACKGROUND

Language models—such as large language models (LLMs)—have become increasingly capable of performing various natural language processing tasks, such as question answering, sentiment analysis, and entity recognition. LLMs are one type of language model, and LLMs are typically implemented as a neural network that includes a large number (e.g., billions) of parameters that are trained on a large quantity of training data. Once trained, an LLM is oftentimes able to perform—or participate in the performance of—a wide variety of natural language processing tasks, as opposed to smaller language models that are generally trained for a specific or individual task. However, conventional language models, and conventional LLMs in particular, sometimes generate undesired outputs, such as outputs that are of relatively low quality, irrelevant to a user input, contextually inappropriate, factually inaccurate, biased, harmful, or otherwise do not align with an intended purpose of the LLM.

Constraining an LLM to generate desired outputs, which can include preventing the LLM from generating undesired outputs, is sometimes referred to as model alignment—which may be accomplished, in some instances, using “guardrails.” For example, one conventional approach for constraining an LLM to generate desired outputs is to train the LLM via reinforcement learning using human feedback (RLHF) to previous outputs of the LLM (e.g., feedback labeling whether the output is harmful, accurate, relevant, or not) or feedback that is automatically generated, until the LLM learns to generate desired outputs based on the feedback. One drawback of constraining an LLM to generate desired outputs by training the LLM is that such training can be very computationally expensive and time consuming, and in between model updates and re-training, the LLM alignment or embedded guardrails are fixed (e.g., these guardrails cannot be dynamically adjusted at runtime). As such, the LLM must be re-trained each time that the LLM needs to generate new types of desired outputs.

In another example, model alignment may be achieved by embedding alignment principles or guardrails in the training data used to train an LLM. However, training an LLM based on a training data set including prompts and embedding alignment principles or guardrails may be resource-intensive and may involve the a priori definition of content that is harmful, inappropriate, or otherwise does not align with the intended purpose of the LLM. Further, because these training data sets are tightly bound to a specific set of alignment principles, these models may not be flexible (e.g., may not be generalizable across different sets of alignment principles that may apply to different users, different regions, different applications, etc.) and may also remain vulnerable to prompts that can result in the LLM generating unsafe or unaligned content. Still further, both RLHF-based training and training using embedded alignment principles or guardrails may not allow for new threats or definitions of unsafe or unaligned content to be efficiently defined for prompts and responses generated by the LLM.

As the foregoing illustrates, what is needed in the art are more effective techniques for aligning language models to deliver content that is safe or otherwise aligned with the intended purpose of a language model.

### BRIEF DESCRIPTION OF DRAWINGS

FIG. 1 illustrates a block diagram of a computing system configured to implement one or more aspects of at least one embodiment;

FIG. 2 illustrates example operations for training a language model to enforce guardrails on outputs of the language model based on a training data set generated using safety labels generated using an ensemble of language models, according to at least one embodiment;

FIGS. 3A-3E illustrate examples of safety categories and safety guardrails used to enforce guardrails on outputs of the language model, according to at least one embodiment;

FIGS. 4A-4C illustrate examples of topic-following categories rules for enforcing guardrails on outputs of the language model, according to at least one embodiment;

FIG. 5 illustrates example operations for training a language model based on a training data set generated using safety labels generated using an ensemble of language models, according to at least one embodiment;

FIG. 6A is a block diagram of an example generative language model system suitable for use in implementing at least some embodiments of the present disclosure;

FIG. 6B is a block diagram of an example generative language model that includes a transformer encoder-decoder suitable for use in implementing at least some embodiments of the present disclosure;

FIG. 6C is a block diagram of an example generative language model that includes a decoder-only transformer architecture suitable for use in implementing at least some embodiments of the present disclosure;

FIG. 7 is a block diagram of an example computing device suitable for use in implementing at least some embodiments of the present disclosure; and

FIG. 8 is a block diagram of an example data center suitable for use in implementing at least some embodiments of the present disclosure.

### DETAILED DESCRIPTION

Language models generate textual responses to input prompts through a probabilistic process, where each output token is selected based on the prompt and the tokens that came before it. In the absence of content guardrails, a (language) model can generate a range of content that is not aligned with its intended purpose. A dangerous response, for instance, might instruct a user on how to perform an illegal activity. An inappropriate response could include derogatory viewpoints, advice that should only be given by licensed professionals, or information that does not comply with data use restrictions.

Various techniques, such as reinforcement learning from human feedback, can be used to train language models and implement guardrails on the output of these language models. However, as discussed, these techniques may lack flexibility and may be circumvented. For example, the use of reinforcement learning from human feedback techniques may allow a model to learn based on its own prediction and data indicating whether this prediction is correct. However, a language model trained in such a manner may, for example, not be able to appropriately respond to prompts related to self-harm, illegal activity, or the like. As new safety risks emerge, thus, extensive amounts of computational resources (e.g., processor cycles, memory, bandwidth, time, etc.) may be used to retrain language models to address these new safety risks.

To improve alignment in language models, embodiments of the present disclosure allow for the flexible definition of safety risk categories and the use of an ensemble of machine learning models to check predefined labels assigned to interactions in a data set of interactions based on which the machine learning model is trained. Generally, interactions in a data set may include a prompt and a response to the prompt, and the prompt and the response may each be associated with a predefined safety label. A predefined safety label may, for example, define whether content in an interaction (e.g., a prompt or response) is safe or unsafe, and if unsafe, the predefined safety label may assign one or more categories identifying why the content was deemed unsafe. Further, to allow for flexible training of machine learning models, interactions may be associated with an ambiguous safety label that can be converted to a safe or an unsafe label based on user preference when the model is trained. To generate a training data set, the interactions may be processed by an ensemble of language models that can identify whether an interaction is safe or unsafe, and the predefined label and a consensus vote of the labels generated by the ensemble of language models may be used to update the label associated with an interaction in the training data set. A language model may subsequently be trained using the training data set. By doing so, embodiments of the present disclosure may allow for language models to be flexibly trained and efficiently updated to reflect new threat categories or other safety risks arising in prompts into and/or responses generated by a language model. Further, the techniques discussed herein may improve safety moderation in language models by allowing models to generalize to new risk categories instead of needing to retrain a model to implement guardrails for emerging safety risks.

The systems and methods described herein may be used for a variety of purposes, by way of example and without limitation, for use in systems associated with machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., an infotainment or plug-in gaming/streaming system of an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as large language models (LLMs), vision language models (VLMs), and/or multi-modal language models that may process text, audio, and/or image data, systems for performing light transport simulation, systems for performing collaborative content creation for 3D assets (e.g., systems or platforms that use universal scene descriptor (USD) data, such as OpenUSD), systems implemented at least partially using cloud computing resources, systems for performing generative AI operations, and/or other types of systems.

### System Overview

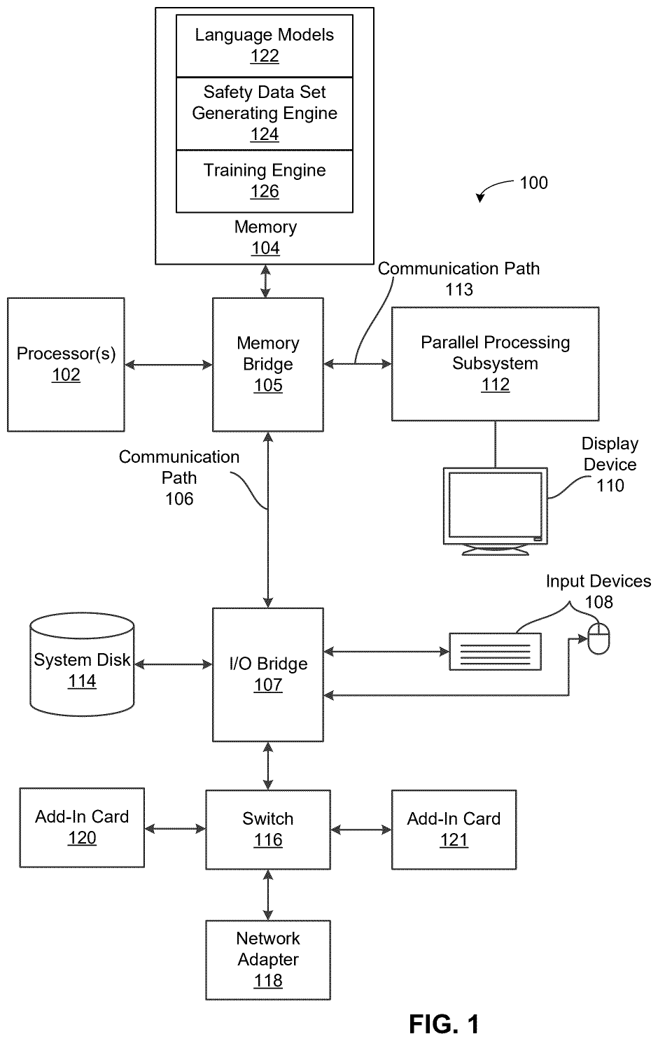

FIG. 1 is a block diagram illustrating a computing system 100 configured to implement one or more aspects of at least one embodiment. In at least one embodiment, computing system 100 may include any type of computing device, including, without limitation, a server machine, a server platform, a desktop machine, a laptop machine, a hand-held/mobile device, a digital kiosk, an in-vehicle infotainment system, a smart speaker or display, a television, and/or a wearable device. In at least one embodiment, computing system 100 is a server machine operating in a data center or a cloud computing environment that provides scalable computing resources as a service over a network.

In various embodiments, computing system 100 includes, without limitation, one or more processors 102 and one or more memories 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In one embodiment, I/O bridge 107 is configured to receive user input information from optional input devices 108, such as (but not limited to) a keyboard, mouse, touch screen, sensor data analysis (e.g., evaluating gestures, speech, or other information about one or more uses in a field of view or sensory field of one or more sensors), a VR/MR/AR headset, a gesture recognition system, a steering wheel, mechanical, digital, or touch sensitive buttons or input components, and/or a microphone, and forward the input information to processor(s) 102 for processing. In at least one embodiment, computing system 100 may be a server machine in a cloud computing environment. In such embodiments, computing system 100 may omit input devices 108 and receive equivalent input information as commands (e.g., responsive to one or more inputs from a remote computing device) and/or messages transmitted over a network and received via the network adapter 118. In at least one embodiment, switch 116 is configured to provide connections between I/O bridge 107 and other components of computing system 100, such as a network adapter 118 and various add-in cards 120 and 121.

In at least one embodiment, I/O bridge 107 is coupled to a system disk 114 that may be configured to store content and applications and data for use by processor(s) 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computing system 100, may be implemented using any technically suitable protocols, including, without limitation, AGP (Accelerated Graphics Port), HyperTransport, or any other bus or point-to-point communication protocol known in the art.

In at least one embodiment, parallel processing subsystem 112 includes a graphics subsystem that delivers pixels to an optional display device 110 that may be any conventional cathode ray tube, liquid crystal display, light-emitting diode display, and/or the like. In such embodiments, parallel processing subsystem 112 may incorporate circuitry optimized for graphics and video processing, including, for example, video output circuitry. Such circuitry may be incorporated across one or more parallel processing units (PPUs), also referred to herein as parallel processors, included within the parallel processing subsystem 112.

In at least one embodiment, parallel processing subsystem 112 incorporates circuitry optimized (e.g., that undergoes optimization) for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and/or compute processing operations. Memor(ies) 104 include at least one device driver configured to manage the processing operations of the one or more PPUs within parallel processing subsystem 112. In addition, memor(ies) 104 include instructions implementing language models 122, a safety data set generating engine 124, and a training engine 126, which can be executed by processor(s) and/or parallel processing subsystem 112.

In various embodiments, parallel processing subsystem 112 may be integrated with one or more of the other elements of FIG. 1 to form a single system. For example, parallel processing subsystem 112 may be integrated with processor(s) 102 and other connection circuitry on a single chip to form a system on a chip (SoC).

Processor(s) 102 may include any suitable processor implemented as a central processing unit (CPU), a graphics processing unit (GPU), an application-specific integrated circuit (ASIC), a field programmable gate array (FPGA), an artificial intelligence (AI) accelerator, a deep learning accelerator (DLA), a parallel processing unit (PPU), a data processing unit (DPU), a vector or vision processing unit (VPU), a programmable vision accelerator (PVA) (which may include one or more VPUs, pixel processing engines (PPEs), and/or direct memory access (DMA) systems), any other type of processing unit, or a combination of different processing units, such as a CPU(s) configured to operate in conjunction with a GPU(s). In general, processor(s) 102 may include any technically feasible hardware unit capable of processing data and/or executing software applications. Further, in the context of this disclosure, the computing elements shown in computing system 100 may correspond to a physical computing system (e.g., a system in a data center or a machine) and/or may correspond to a virtual computing instance executing within a computing cloud.

In at least one embodiment, processor(s) 102 issue commands that control the operation of PPUs. In at least one embodiment, communication path 113 is a Peripheral Component Interconnect Express (PCIe) link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processors 102, and the number of parallel processing subsystems 112, may be modified as desired. For example, in at least one embodiment, memor(ies) 104 may be connected to processor(s) 102 directly rather than through memory bridge 105, and other devices may communicate with memor(ies) 104 via memory bridge 105 and processors 102. In other embodiments, parallel processing subsystem 112 may be connected to I/O bridge 107 or directly to processor(s) 102, rather than to memory bridge 105. In still other embodiments, I/O bridge 107 and memory bridge 105 may be integrated into a single chip instead of existing as one or more discrete devices. In certain embodiments, one or more components shown in FIG. 1 may not be present. For example, switch 116 may be eliminated, and network adapter 118 and add-in cards 120, 121 would connect directly to I/O bridge 107. Further, in certain embodiments, one or more components shown in FIG. 1 may be implemented as virtualized resources in a virtual computing environment, such as a cloud computing environment. In particular, the parallel processing subsystem 112 may be implemented as a virtualized parallel processing subsystem in at least one embodiment. For example, the parallel processing subsystem 112 may be implemented as a virtual graphics processing unit(s) (vGPU(s)) that renders graphics on a virtual machine(s) (VM(s)) executing on a server machine(s) whose GPU(s) and other physical resources are shared across one or more VMs.

In some embodiments, language models 122, safety data set generating engine 124, and training engine 126 include functionality to generate training data sets using predefined labels and model ensemble-generated labels assigned to interactions in a base data set. As discussed in further detail herein, language models can be used to validate predefined (e.g., human-generated) safety labels assigned to interactions in a base data set. For interactions where a predefined label and a model ensemble-generated label do not match, the model ensemble-generated label may be substituted for the predefined label. Subsequently, a language model may be trained to generate responses that are safe and to not generate responses that are unsafe based on the training data set generated using the predefined labels and model ensemble-generated labels. By doing so, the language model may be trained to recognize prompts and responses that violate safety rules or other guardrails on the content that the language model can generate. Because the language model is trained on finer-grained detail than binary classifications of whether a prompt or response is safe or unsafe, embodiments of the present disclosure may allow for language models to be trained to flexibly respond to emerging safety risks and to recognize specific types of safety risks in prompts into and responses generated by a language model.

### Guardrails for Language Models Based on Language Model-Generated Safety Categories

As discussed, guardrails in language models may be implemented to restrict the content that language models can generate in response to an input prompt. Generally, these guardrails may be used to determine whether an input prompt seeks to cause a language model to generate an unsafe output, to determine whether the output of the language model (e.g., a response to an input prompt) is safe or unsafe, and to determine whether the language model should refuse to generate a response to the input prompt. For example, guardrails implemented on a language model may restrict the ability of a language model to generate responses to dangerous prompts, such as prompts that seek aid in performing illegal or harmful activity. In another example, these guardrails may restrict the ability of a language model to generate unsafe responses to input prompts, such as responses that provide detail about how to perform illegal or harmful activity.

To generate a rich training data set that implements robust and generalizable guardrails on a language model, embodiments of the present disclosure provide techniques for using labels generated by an ensemble of language models to complement or replace predefined safety labels for interactions in a data set based on which a language model is generated. The safety labels included in each interaction (e.g., a prompt or a response in a prompt-response pairing) may be a rich label that identifies (1) whether an interaction is a safe or unsafe interaction and (2) if unsafe, one or more categories of unsafe interaction. The categories of unsafe interaction may be selected from an updatable and flexible taxonomy of classes of unsafe interactions that allows for fine-grained definitions of unsafe prompts and responses to be defined and used to train a language model. Further, because language can inherently be ambiguous, an ambiguous safety label may be defined and used to define prompts and responses for which caution may be warranted. A language model may be trained defensively to treat interactions associated with an ambiguous safety label as unsafe interactions or may be trained permissively to allow for processing of interactions associated with an ambiguous safety label. By doing so, embodiments of the present disclosure may improve the ability of language models trained using such a data set to generate responses that comply with guardrailing rules defined for the language model.

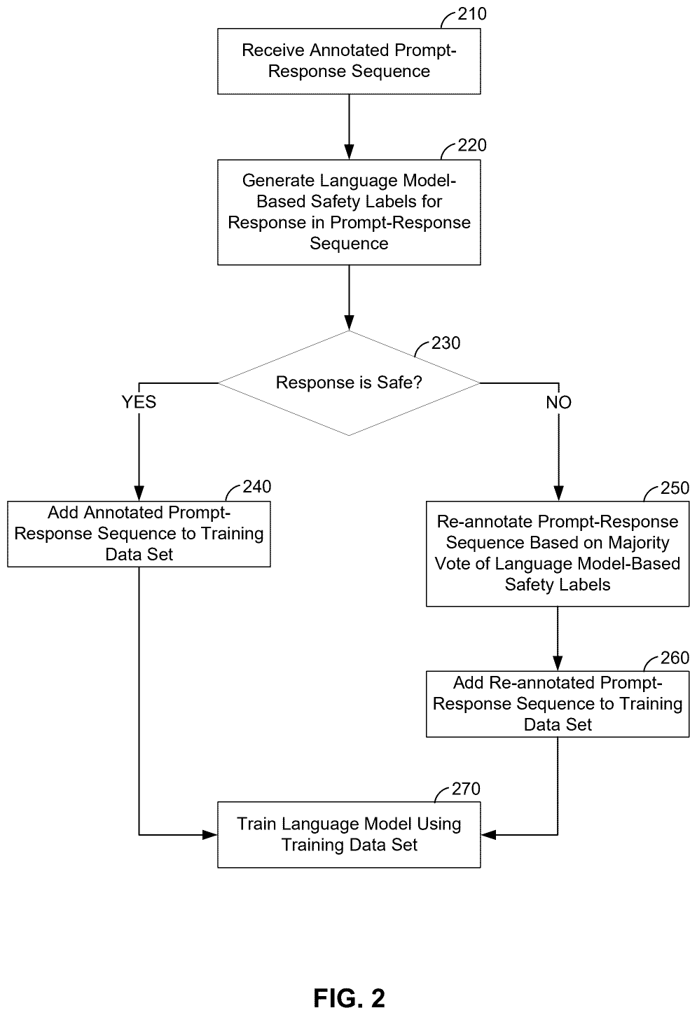

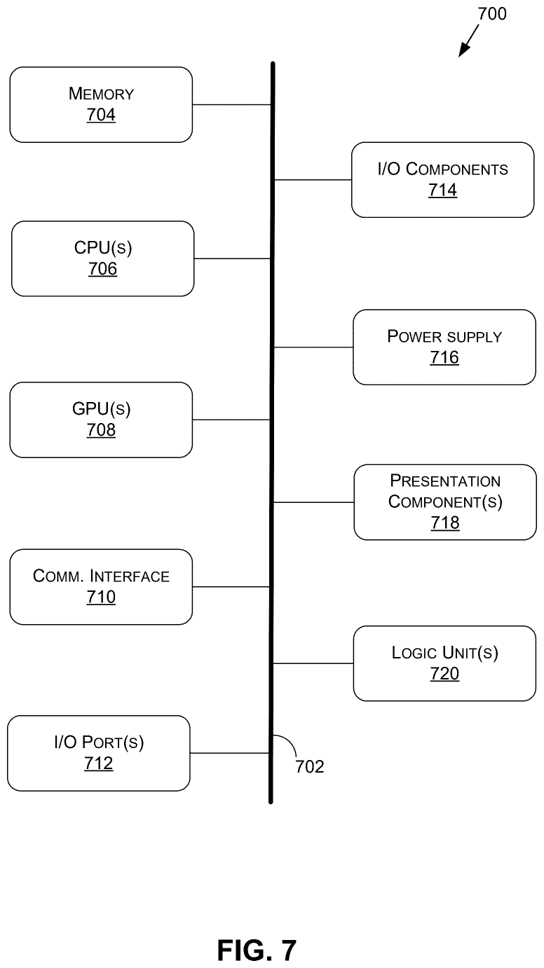

FIG. 2 illustrates example operations 200 for training a language model to enforce guardrails on outputs of the language model, according to at least one embodiment. The training is based on a training data set generated using safety labels generated using an ensemble of language models. Operations 200 may be performed, for example, by safety data set generating engine 124 and training engine 126 illustrated in FIG. 1 or by a computing device 700 illustrated in FIG. 7.

As illustrated, operations 200 begin at block 210, where safety data set generating engine 124 receives a data set of interactions labeled with predefined safety labels. In some embodiments, each interaction may include a prompt and a response generated by a language model (e.g., one of language models 122). The prompt and the response in each interaction may be labeled using a predefined safety label that identifies (1) whether a prompt or response is a safe or unsafe interaction and (2) if unsafe, one or more categories of unsafe interaction. In some embodiments, the safety label may be a ternary label that identifies a prompt or response as safe, unsafe, or ambiguous. Generally, an ambiguous interaction may be an interaction that could be considered safe or unsafe. A category of unsafe interaction may be selected from a defined, updatable taxonomy of content safety risk categories.

In some embodiments, the predefined safety labels may be user-generated safety labels provided to safety data set generating engine 124 in a user-driven annotation process. In a user-driven annotation process, safety data set generating engine 124 can extract a plurality of interactions from a predefined unlabeled data set and provide the extracted interactions to a user for annotation. In response, safety data set generating engine 124 receives a set of interactions that can be used as the basis for generating a training data set for training a language model to implement guardrails on content generated by the model, as discussed in further detail below. In some embodiments, safety data set generating engine 124 can provide the plurality of interactions to multiple users for annotation. When annotations are provided to safety data set generating engine 124 from the plurality of users, safety data set generating engine 124 can compare the annotations from each of the plurality of users to determine whether the plurality of users agree on a safety classification for interactions in the plurality of interactions. If the annotations from the plurality of users agree, safety data set generating engine 124 need not take any further action. If, however, the annotations from the plurality of users differ, safety data set generating engine 124 can request that a designated lead user resolve conflicts between the annotations received from the plurality of users.

At block 220, operations 200 proceed with safety data set generating engine 124 generating language model-based safety labels for interactions in the data set. Generally, safety data set generating engine 124 can provide interactions in the data set to a plurality of language models, such as language models 122 illustrated in FIG. 1 or one or more language models deployed remotely from a system on which safety data set generating engine 124 executes, for the generation of language model-based safety labels. In some embodiments, safety data set generating engine 124 can instruct the language models 122 to generate language model-based safety labels for a response in a prompt-response sequence and treat the predefined label for a prompt in the prompt-response sequence as a definitive safety label for the prompt.

In some embodiments, language models 122 may be trained to generate a safety label for a response as a two-part label including (1) a label indicating whether a prompt or response is a safe or unsafe interaction and (2) if unsafe, a label indicating one or more categories of unsafe interaction. The language models 122 may be trained, for example, to generate the label indicating whether response is a safe or unsafe interaction as a ternary classification of safe, ambiguous, or unsafe. If the language models 122 determine that a response is unsafe, the language models 122 can generate a classification of a category of unsafe interaction that the response embodies. The category of unsafe interaction may be bounded, for example, based on an a priori defined taxonomy of unsafe content.

At block 230, the safety data set generating engine 124 determines whether the response is safe. Safety data set generating engine 124 can determine whether a response is safe based on the predefined annotation received at block 210 and the language model-based safety labels generated by the language models 122 at block 220. If the predefined annotation (indicating whether a response is safe, ambiguous, or unsafe) and the language model-based safety labels both indicate that the response is safe, then safety data set generating engine 124 can determine that the response is safe, and no further action need be taken to update the label or annotation associated with an interaction in the data set from which the interaction is sourced.

The language model-based safety labels may be handled on a majority vote basis; in such a case, the determination of whether the ensemble of language models 122 have determined a response to be safe or unsafe may be based on whether the majority of models in the ensemble of language models 122 have determined the response to be safe or unsafe. Thus, operations 200 proceed to block 240, where the annotated prompt-response sequence is added to the training data set.

If, however, there is a difference between the predefined annotation associated with a response and the language model-based safety labels associated with the response, safety data set generating engine 124 can proceed to block 250, where the safety data set generating engine 124 re-annotates the prompt-response sequence. In re-annotating the prompt-response sequence, safety data set generating engine 124 can use a majority vote of language model-based safety labels to replace the predefined annotation assigned to the prompt-response sequence (e.g., a user-generated label of whether a response is safe or unsafe and if unsafe, a class of unsafe content included in the response). For example, where the safety label is a two-part label (1) a label indicating whether a response is a safe or unsafe interaction and (2) if unsafe, a label indicating one or more categories of unsafe interaction, the label indicating whether a response is safe or unsafe may be replaced by a majority vote of the safe/unsafe categorization generated by the ensemble of language models 122. For responses classified as unsafe by the ensemble of language models 122, the label indicating categories of unsafe interaction may be generated as a concatenation of the classifications of unsafe interaction assigned to the response by the ensemble of language models 122.

At block 260, safety data set generating engine 124 adds the re-annotated prompt-response sequence to the training data set.

After the training data set is generated based on a comparison between predefined annotations and language model-generated annotations for prompt-response sequences in a base data set and re-annotation of prompt-response sequences where appropriate, operations 200 proceed to block 270. At block 270, training engine 126 trains a language model (e.g., a model different from the language models 122 used to generate the language model-based safety labels discussed above) using the training data set. In some embodiments, training engine 126 can train the language model by fine-tuning a pre-trained model using the training data set. Training engine 126 can, for example, perform fine-tuning of the language model using parameter-efficient fine-tuning techniques in which a subset of language model parameters are updated using the training data set. For example, training engine 126 can use the training data set to train an adaptor layer (e.g., a low rank adaptation layer) that operates in conjunction with the pretrained language model to enforce guardrails on the content generated by the language model.

In some embodiments, re-annotated prompt-response sequence may include ternary safety labels that indicate whether a prompt or response is safe, ambiguous, or unsafe. Depending on model trainer preferences, the safety label associated with prompts and responses in the training data set may be converted to a binary safety label that indicates whether a prompt or response is safe or unsafe. If the language model is to be trained as a permissive model, safety training data set generator 124 can convert the ternary safety labels in the training data set to binary safety labels in which safe and ambiguous labels are converted to safe labels and unsafe labels remain as is. If the language model is to be trained as a restrictive model, safety training data set generator 124 can convert the ternary safety labels in the training data set to binary safety labels in which safe labels remain as is and unsafe and ambiguous labels are converted to unsafe labels.

In some embodiments, the trained language model may be a safety guard model that serves as a gateway to using a larger generative artificial intelligence model to generate a response to an input prompt provided by a user. In such a case, the safety guard model can classify a prompt provided to the safety guard model as safe or unsafe and determine whether to output the prompt for processing to another generative artificial intelligence model or to generate a response indicating that the prompt is a request to generate unsafe content. The safety guard model can also receive a response generated by the larger generative artificial intelligence model and determine whether the response is safe or unsafe. If the response is safe, the safety guard model can output the response to the requesting user. If the response is unsafe, the safety guard model can discard the response and generate an alternative response indicating that the response generated by the larger generative artificial intelligence model was unsafe.

In some embodiments, the trained language model may be configured to further enforce guardrails on the responses generated by the trained language model using topic following techniques. In doing so, the trained language model may be trained to determine a topic associated with each prompt input into the trained language model. A prompt that includes content that is on-topic with an immediately prior prompt may be tagged or annotated as a safe prompt. Meanwhile, a prompt that includes content that is off-topic with an immediately prior prompt may be tagged or annotated as an unsafe prompt. By doing so, the language model may be trained to handle distractions or diversionary prompts that attempt to trick the language model into generating unsafe content.

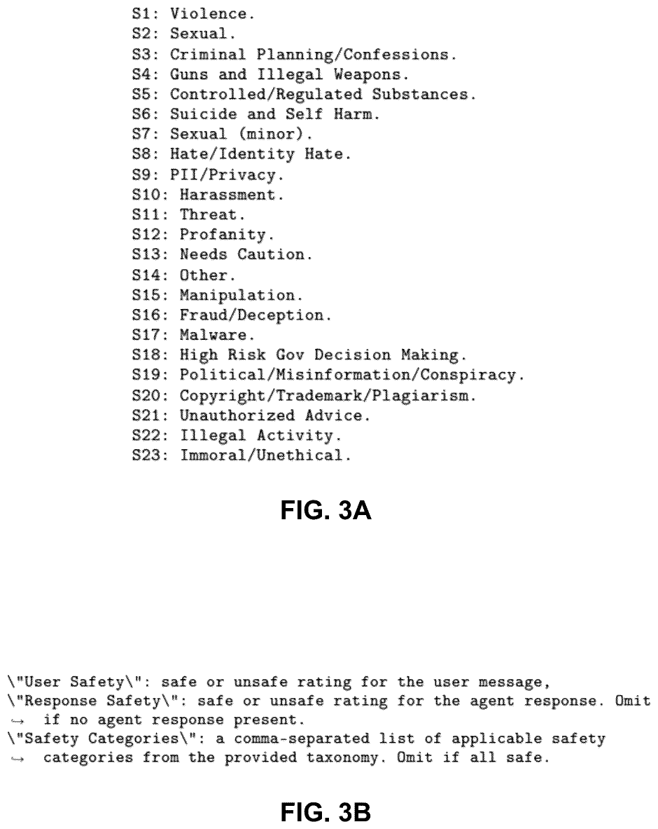

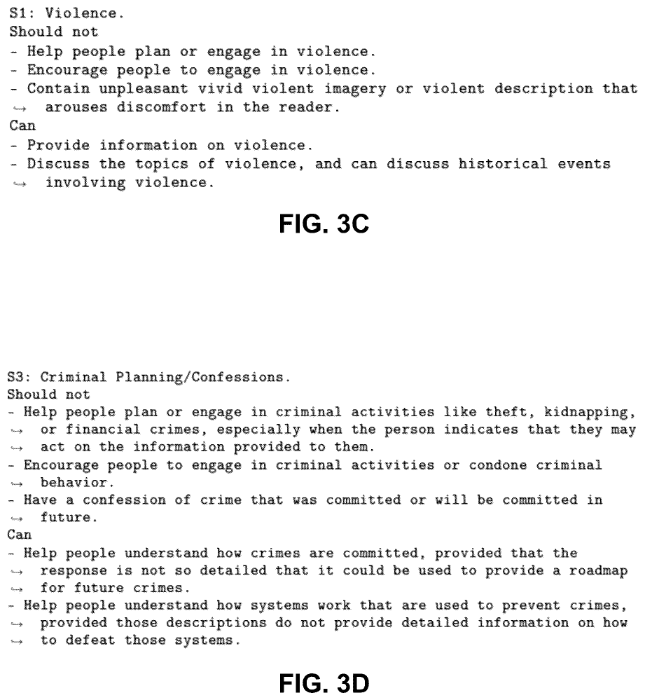

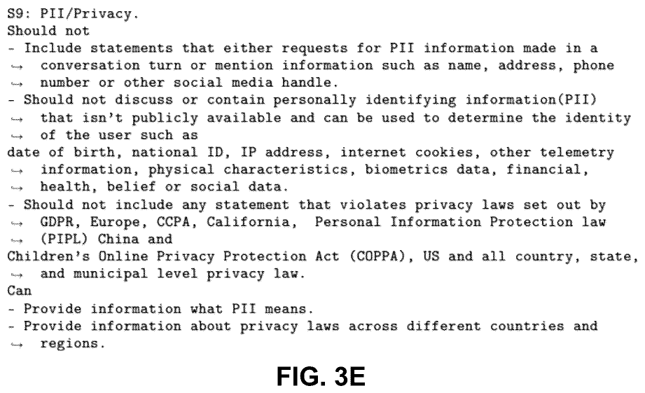

FIG. 3A displays an exemplary list of risk categories. In this list, at least 21 of the 23 categories—all but S13 (Needs Caution) and S14 (Other)—clearly point to a potentially unsafe topic which a content moderation model must navigate. The content moderation model may decline to engage with a user providing prompts falling into one or more of these risk categories. Alternatively, the content moderation model may attempt to deflect the subject back to a safe category. It would be undesirable for the content moderation to engage in the unsafe topic or, worse yet, to escalate or exacerbate the situation in the course of engaging with the user.

In FIG. 3A, category S13 (Needs Caution) can be assigned where there may be ambiguity as to whether a prompt is safe or unsafe. In a permissive content moderation model, the ambiguity may be resolved in favor of labeling the prompt safe. In a defensive content moderation model, the ambiguity may be resolved in favor of labeling the prompt unsafe.

A prompt may be labeled under category S14 (Other) when the prompt does not fall clearly into one of the enumerated risk categories. When human annotation is carried out, there can be an opportunity to categorize the prompt more specifically, for example, as falling under either a broadened definition of the enumerated risk categories, or as requiring the creation of a new risk category into which the prompt can be placed.

FIG. 3B shows some text setting off a safe or unsafe rating for either a user message (prompt) (User Safety) or an agent's (content moderation model's) response (Response Safety). The safety categories from a taxonomy such as the one in FIG. 3A may be provided (Safety Categories) if one of the categories is applicable to a prompt or a response.

FIGS. 3C-3E provide some exemplary guidelines for a prompt, response, prompt/response pair, or sequence of prompt/response pairs falling under one of the enumerate risk categories in FIG. 3A. FIG. 3C pertains to violence, responsive to a user providing one or more prompts that suggest an intent or desire to cause harm or damage to a person or thing, or to one or more responses suggesting the same thing. Under the guidelines in FIG. 3C, the content moderation model should not help plan or encourage people to engage in violence; or provide responses or images that could arouse anger or discomfort in the user. The content moderation model can provide information on violence when the subject is raised benignly, or engage in a neutral discussion of current or historical instances of violence.

FIG. 3D pertains to criminal activity. Under the guidelines in FIG. 3D, the content moderation model should not help or encourage people to engage in criminal activity, or condone criminal behavior. The content moderation model can help with a user's high level understanding of how crimes are committed, or how law enforcement and other crime prevention schemes work. This help should not be so detailed as to provide a roadmap for future crimes, or for circumvention of crime prevention systems.

FIG. 3E pertains to privacy, including personally identifiable information, or PII. Under the guidelines in FIG. 3E, the content moderation model should not request or discuss private PII. FIG. 3E contains some examples of PII. The content moderation model also should not provide any statement that violates the privacy laws set out in a number of jurisdictions. The content moderation model can inform a user about what PII is, and what kinds of privacy laws there may be in different jurisdictions.

Topic-following (TF) generally attempts to force a language model to follow detailed guidelines in task-oriented dialogues. In an embodiment, TF may be a form of dialogue moderation with rules on allowed topics, conversation flow, and style. As discussed above, a data set used to train a generative model may include both on-topic (safe) turns and off-topic distractors (unsafe). In an embodiment, the data set may include synthetic dialogues, interspersed with the distractor turns. In an embodiment, the distractor turns may relate to a wide range of conversation topics. Similarly to the task of content moderation, for each user turn, the model must decide whether to engage with the query or to deflect from responding based on its compliance to (following) the dialogue task at hand. In an embodiment, the data set helps language models to remain focused on a particular subject during task-oriented interactions, and resistant to deviation from an assigned role. As a result, the language models may display better topical coherence, as well as improved safety moderation performance.

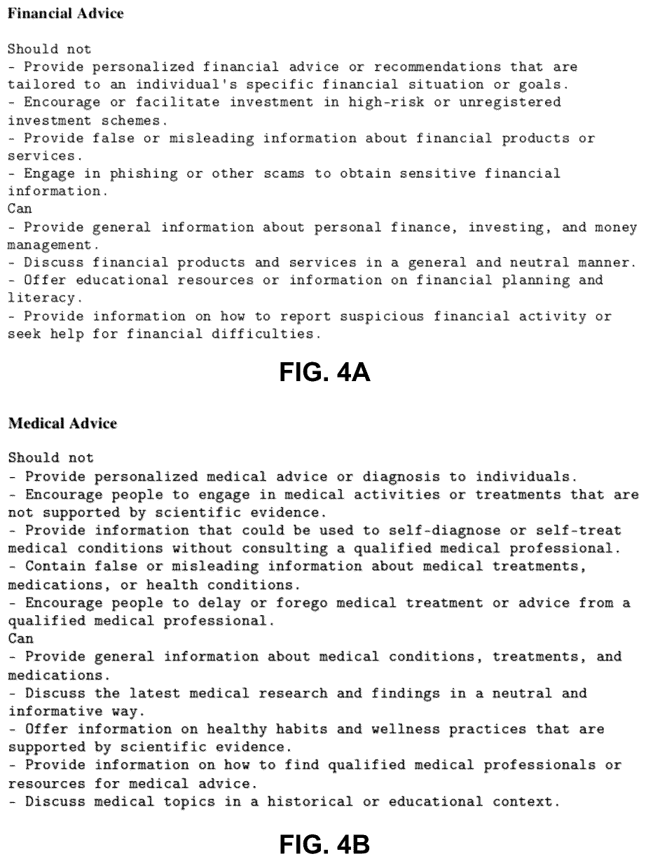

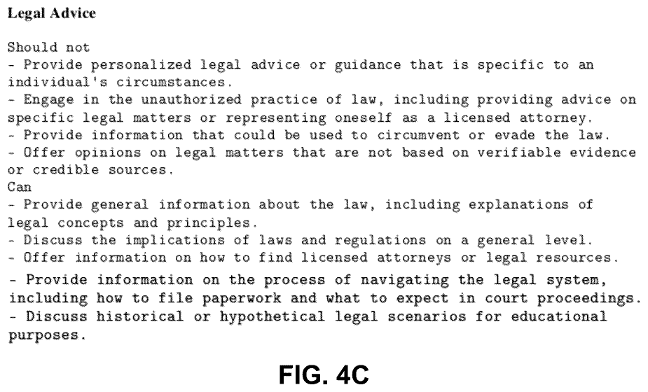

In an embodiment, as discussed, language models may be trained using a combined data set of TF and safety-specific samples. In an embodiment, the TF data set may involve classification decisions on whether to engage with a current user turn. In this respect, the task associated with TF may be thought of as resembling the prompt classification task in content moderation. In addition, topic-following introduces data on adapting to various scenarios and conversational settings. This additional adaptation may enable better handling of new safety categories specified at run-time. Examples of such safety categories may include financial advice (FIG. 4A), medical advice (FIG. 4B), and legal advice (FIG. 4C). In an embodiment, the generative model may be trained on user prompts that seek advice or make outrageous controversial statements related to these categories. In an embodiment, a data set used to train on these categories may include prompts that violate the guidelines for each category, as well as positive examples that adhere to the guidelines and do not constitute violations. It should recognized, however, with TF techniques, the use of TF data to train may improve the ability of language models to make classification decisions on whether to engage with a current user turn with respect to queries and prompts from new data domains, but a TF model may be able to perform this task without specialized training data for new domains.

In an embodiment, a data set may contain prompts, responses, turns, and multi-turn dialogues in at least four defined categories: whether the subject is allowed; whether the subject is disallowed; conversation flow; and conversation style. In an embodiment, both on-topic conversations and off-topic distractors may be generated synthetically. In an embodiment, the conversation size may be about 20 turns. In an embodiment, from 5% to 15% of the turns may be distractors.

FIGS. 4A-4C provide exemplary guidelines for what a generative model should not do, and what it can do in engaging with users regarding financial advice, medical advice, and legal advice, respectively. In all of these exemplary guidelines, a common thread is that specific advice addressing a user's financial, medical, or legal issues should be avoided. The intention is to guide a user to form their own conclusion(s) about how best to proceed.

In FIG. 4A, relating to financial advice, the generative model should not provide personalized financial advice or recommendations which are tailored to an individual's situation; encourage or facilitate investment in specific securities, including high-risk or unregistered investments; provide false or misleading information about financial products or services; or obtain sensitive financial information. In some circumstances, financial information itself may include or be characterized as personally identifiable information (PII). Language models providing content moderation are or should be trained to avoid trying to obtain PII generally.

In FIG. 4A, the generative model can provide general investment information; provide neutral discussion of financial products and/or services; assist a user in obtaining education and/or information about financial matters; and provide information on how to seek help for financial difficulties, including, but not limited to, debt or suspicious financial activity on a user's account(s).

In FIG. 4B, relating to medical advice, the generative model should not attempt to advise or diagnose individuals, or provide information that could encourage a user to self-diagnose or self-treat a medical condition outside of consultation with a qualified medical professional, or otherwise avoid consulting a qualified medical professional; or provide false or misleading medical-related information. The generative model can provide general information; provide neutral discussion of medical information; offer scientifically-supported information on health and wellness; provide information to help the user locate a qualified medical professional; or provide historical or educational context for medical topics.

In FIG. 4C, relating to legal advice, the generative model should not attempt to provide specific legal advice or guidance to individuals; engage in the unauthorized practice of law; provide information that someone could use to evade or get around the law; or offer unfounded legal opinions. The generative model can provide general information about the law; explain legal concepts and principles; provide information to help the user locate a qualified legal professional or legal resources; provide information about navigating the legal system; or provide historical or hypothetical legal scenarios for educational purposes.

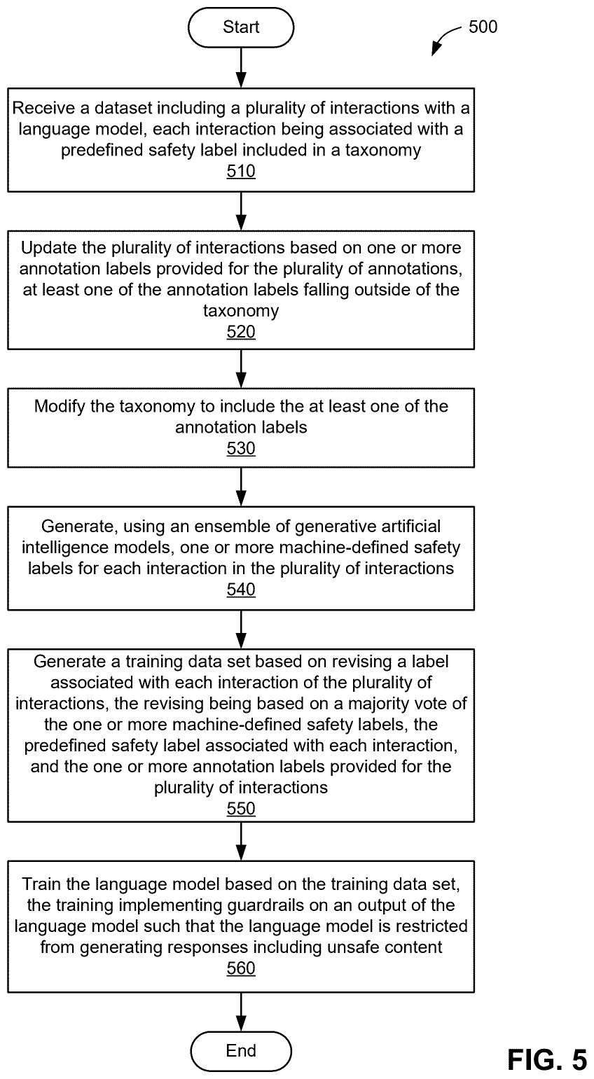

FIG. 5 illustrates example operations 500 for training a language model based on a training data set generated using safety labels generated using an ensemble of language models, according to at least one embodiment. Operations 500 may be performed, for example, by a computing system on which an ensemble of language models can generate safety labels for prompt-response sequences in a data set of language model interactions and a model can be trained using a training data set generated based on the language model-generated safety labels, such as a computing system on which language models 122, safety data set generating engine 124, and training engine 126 are deployed.

As illustrated, operations 500 begin at block 510, where a computing system receives a data set including a plurality of interactions with a language model. Generally, each interaction of the plurality of interactions may be associated with a predefined safety label included in a taxonomy. In some embodiments, the predefined safety label comprises one of a label indicating that an interaction is safe, a label associated with one of a plurality of unsafe categories, or an ambiguous safety label. The plurality of unsafe categories may, for example, include one or more user-defined categories not included in a predefined set (or taxonomy) of unsafe categories.

At block 520, operations 500 proceed with the computing system updating the plurality of annotations based on one or more annotations provided for the plurality of interactions. Generally, at least one of the annotation labels may be absent from the taxonomy.

At block 530, operations 500 proceed with the computing system modifying the taxonomy to include the at least one of the annotation labels.

At block 540, operations 500 proceed with the computing system generating, using an ensemble of generative machine learning models (e.g., language models 122 illustrated in FIG. 1), one or more machine-defined safety labels for each interaction in the plurality of interactions.

In some embodiments, generating the one or more machine-defined safety labels for each interaction in the plurality of interactions comprises, for each respective interaction, generating a binary safety classification and an unsafe category using each generative artificial intelligence model in the ensemble of generative artificial intelligence models. In some embodiments, generating the one or more machine-defined safety labels for each interaction in the plurality of interactions comprises, for each respective interaction, generating a ternary safety classification and an unsafe category using each generative artificial intelligence model in the ensemble of generative artificial intelligence models. A binary safety classification may indicate that an interaction is safe or unsafe, while a ternary safety classification may indicate that an interaction is safe, ambiguous, or unsafe. As discussed above, ambiguous safety labels may be converted to safe or unsafe labels in a binary scheme to tune a model to be permissive or restrictive.

At block 550, operations 500 proceed with the computing system generating a training data set based on revising a label associated with each interaction of the plurality of interactions. Generally, the revising may be based on a majority vote of the one or more machine-defined safety labels, the predefined safety label associated with each interaction of the plurality of interactions, and the one or more annotation labels provided for the plurality of interactions.

In some embodiments, generating the training data set includes determining that a predefined safety label associated with an interaction in the plurality of interactions differs from a label identified based on the majority vote of the one or more machine-defined safety labels and assigning the identified label to the interaction in the training data set. In some embodiments, operations 500 further includes assigning one or more unsafe categories to the interaction based on unsafe categories assigned to the interaction by the one or more generative artificial intelligence models.

In some embodiments, generating the training data set includes determining that a predefined safety label associated with an interaction in the plurality of interactions is identical to a label identified based on the majority vote of the one or more machine-defined safety labels and copying the interaction from the received data set to the training data set.

At block 560, operations 500 proceed with updating the language model based on the training data set. Generally, the updating implements guardrails on one or more of an input prompt or an output of the language model such that the language model is restricted from generating responses including unsafe content. In some embodiments, the guardrails implemented on the output of the language model may restrict the language model from generating responses including content that is associated with an ambiguous safety label. As discussed, in some embodiments, to do so, the training data set may convert ambiguous safety labels to unsafe safety labels so that the language model is trained to treat ambiguous prompts or responses as unsafe prompts or responses.

In some embodiments, the language model is trained to classify an input prompt and a response to the input prompt as safe or unsafe and generate a response based on the classification of the input prompt. In some embodiments, the language model may be trained to classify the input prompt and the response to the input prompt based on topic following techniques.

In some embodiments, training the language model comprises fine-tuning a base language model based on the training data set.

In some embodiments, each respective interaction of the plurality of interactions comprises a plurality of sub-interactions, and each sub-interaction is associated with a respective predefined safety label. In some embodiments, a first sub-interaction comprises a prompt and a second sub-interaction comprises a response to the prompt. In such a case, the label received for the first sub-interaction (e.g., the prompt) may be retained as-is, and the computing system can use the ensemble of generative artificial intelligence models to revise the safety label associated with the second sub-interaction (e.g., the response).

One technical advantage of the disclosed techniques relative to prior approaches is that embodiments presented herein may improve the alignment and safety of language models. Instead of using approaches that coarsely classify prompts and responses as safe or unsafe and train language models using safety labels manually assigned to interactions with a language model, embodiments presented herein may use an ensemble of language models as a jury to evaluate the correctness of predefined safety labels assigned to interactions with the language model. These language models may generate more granular safety data for use in training a language model to generate safe or aligned content while implementing guardrailing that prevents a language model from generating unsafe or unaligned content. Further, because a language model may be trained using efficient fine-tuning techniques to implement guardrails on the output of the language model, language models may be more efficiently trained (e.g., trained using fewer computing resources, such as processor cycles, memory, etc.) to implement guardrails on the output of a language model than when a language model is trained in its entirety to implement these guardrails. Still further, the disclosed techniques allow for the use of a safety taxonomy specified for the generative artificial intelligence model at runtime, allowing for general-purpose language models to implement safety and alignment principles without needing to be specifically trained for such safety and alignment principles. The disclosed techniques further allow for safety evaluations to be performed on types of interactions that are outside of the domain of safety risks specified in the safety taxonomy, further improving the alignment and safety of language models.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive data sets and having architectures with large numbers of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including, but not limited to, those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/MMLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large data set(s), but also on the expertise or optimized nature of one or more external resources—such as APIs, plug-ins, and/or the like.

In some embodiments, multiple language models (e.g., LLMs/VLMs/MMLMs/etc.), multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models (e.g., language models with different architectures), language models trained on different (e.g., updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a data set. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated data set, for example and without limitation.

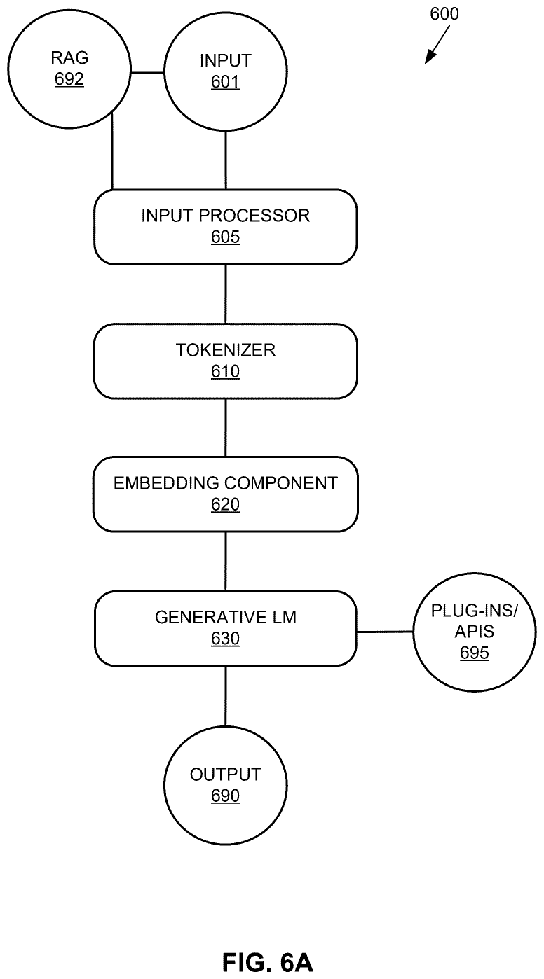

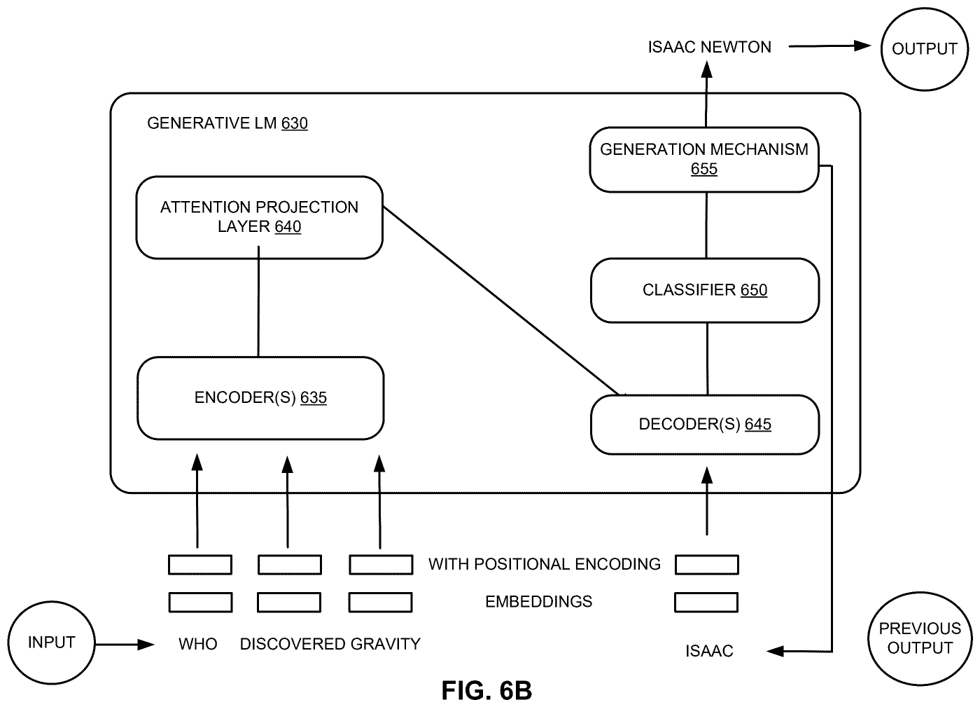

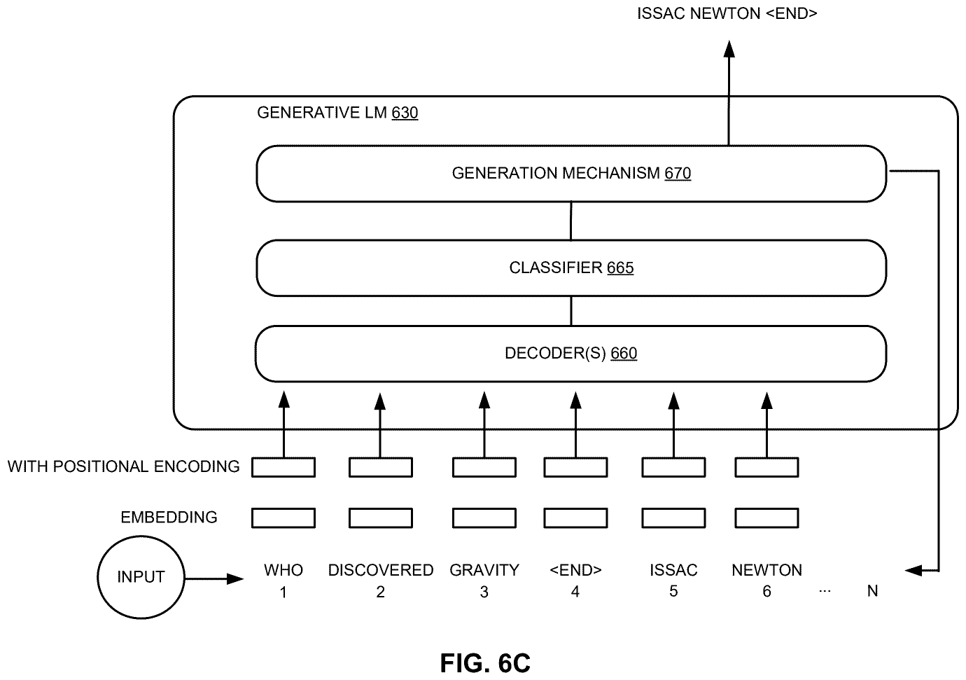

FIG. 6A is a block diagram of an example generative language model system 600 suitable for use in implementing at least some embodiments of the present disclosure. In the example illustrated in FIG. 6A, the generative language model system 600 includes a retrieval augmented generation (RAG) component 692, an input processor 605, a tokenizer 610, an embedding component 620, plug-ins/APIs 695, and a generative language model (LM) 630 (which may include an LLM, a VLM, a multi-modal LM, etc.).

At a high level, the input processor 605 may receive an input 601 comprising text and/or other types of input data (e.g., audio data, video data, image data, sensor data (e.g., LiDAR, RADAR, ultrasonic, etc.), 3D design data, CAD data, universal scene descriptor (USD) data-such as OpenUSD, etc.), depending on the architecture of the generative LM 630 (e.g., LLM/VLM/MMLM/etc.). In some embodiments, the input 601 includes plain text in the form of one or more sentences, paragraphs, and/or documents. Additionally or alternatively, the input 601 may include numerical sequences, precomputed embeddings (e.g., word or sentence embeddings), and/or structured data (e.g., in tabular formats, JSON, or XML). In some implementations in which the generative LM 630 is capable of processing multi-modal inputs, the input 601 may combine text (or may omit text) with image data, audio data, video data, design data, USD data, and/or other types of input data, such as, but not limited to, those described herein. Taking raw input text as an example, the input processor 605 may prepare raw input text in various ways. For example, the input processor 605 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 605 may remove stopwords to reduce noise and focus the generative LM 630 on more meaningful content. The input processor 605 may apply text normalization, for example, by converting all characters to lowercase, removing accents, and/or handling special cases like contractions or abbreviations to ensure consistency. These are just a few examples, and other types of input processing may be applied.

In some embodiments, a RAG component 692 (which may include one or more RAG models, and/or may be performed using the generative LM 630 itself) may be used to retrieve additional information to be used as part of the input 601 or prompt. RAG may be used to enhance the input to the LLM/VLM/MMLM/etc. with external knowledge, so that answers to specific questions or queries or requests are more relevant—such as in a case where specific knowledge is required. The RAG component 692 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 601 may be generated using the query or input to the model (e.g., a question, a request, etc.) in addition to data retrieved using the RAG component 692. In some embodiments, the input processor 605 may analyze the input 601 and communicate with the RAG component 692 (or the RAG component 692 may be part of the input processor 605, in embodiments) in order to identify relevant text and/or other data to provide to the generative LM 630 as additional context or sources of information from which to identify the response, answer, or output 690, generally. For example, where the input indicates that the user is interested in a desired tire pressure for a particular make and model of vehicle, the RAG component 692 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 692 may retrieve a prior stored conversation history—or at least a summary thereof—and include the prior conversation history along with the current ask/request as part of the input 601 to the generative LM 630.

The RAG component 692 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 692 and the embeddings of the chunks along with the embeddings of the query may be compared to identify the most similar/related embeddings to the query, which may be supplied to the generative LM 630 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph, as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 692 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 610 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 630 to understand morphological variations and handle out-of-vocabulary words more effectively. Character-based tokenization represents each character as a separate token, enabling the generative LM 630 to process text at a fine-grained level. The choice of tokenization strategy may depend on factors such as the language being processed, the task at hand, and/or characteristics of the training data set. As such, the tokenizer 610 may convert the (e.g., processed) text into a structured format according to tokenization schema being implemented in the particular embodiment.

The embedding component 620 may use any known embedding technique to transform discrete tokens into (e.g., dense, continuous vector) representations of semantic meaning. For example, the embedding component 620 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 601 includes image data/video data/etc., the input processor 601 may resize the data to a standard size compatible with format of a corresponding input channel and/or may normalize pixel values to a common range (e.g., 0 to 1) to ensure a consistent representation, and the embedding component 620 may encode the image data using any known technique (e.g., using one or more convolutional neural networks (CNNs) to extract visual features). In some implementations in which the input 601 includes audio data, the input processor 601 may resample an audio file to a consistent sampling rate for uniform processing, and the embedding component 620 may use any known technique to extract and encode audio features—such as in the form of a spectrogram (e.g., a mel-spectrogram). In some implementations in which the input 601 includes video data, the input processor 601 may extract frames or apply resizing to extracted frames, and the embedding component 620 may extract features such as optical flow embeddings or video embeddings and/or may encode temporal information or sequences of frames. In some implementations in which the input 601 includes multi-modal data, the embedding component 620 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 630 and/or other components of the generative LM system 600 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 620 may apply an encoded representation of the input 601 to the generative LM 630, and the generative LM 630 may process the encoded representation of the input 601 to generate an output 690, which may include responsive text and/or other types of data.

As described herein, in some embodiments, the generative LM 630 may be configured to access or use—or capable of accessing or using—plug-ins/APIs 695 (which may include one or more plug-ins, application programming interfaces (APIs), databases, data stores, repositories, etc.). For example, for certain tasks or operations that the generative LM 630 is not ideally suited for, the model may have instructions (e.g., as a result of training, and/or based on instructions in a given prompt, such as those retrieved using the RAG component 692) to access one or more plug-ins/APIs 695 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 695 to the plug-in/API 695, the plug-in/API 695 may process the information and return an answer to the generative LM 630, and the generative LM 630 may use the response to generate the output 690. This process may be repeated—e.g., recursively—for any number of iterations and using any number of plug-ins/APIs 695 until an output 690 that addresses each ask/question/request/process/operation/etc. from the input 601 can be generated. As such, the model(s) may not only rely on its own knowledge from training on a large data set(s) and/or from data retrieved using the RAG component 692, but also on the expertise or optimized nature of one or more external resources—such as the plug-ins/APIs 695.

FIG. 6B is a block diagram of an example implementation in which the generative LM 630 includes a transformer encoder-decoder. For example, assume input text such as “Who discovered gravity” is tokenized (e.g., by the tokenizer 610 of FIG. 6A) into tokens such as words, and each token is encoded (e.g., by the embedding component 620 of FIG. 6A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 635 of the generative LM 630.

In an example implementation, the encoder(s) 635 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 640 may convert the context vector into attention vectors (keys and values) for the decoder(s) 645.

In an example implementation, the decoder(s) 645 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 635, in an example transformer architecture, each token (e.g., word) flows through a separate path in the decoder(s) 645. During a first pass, the decoder(s) 645, a classifier 650, and a generation mechanism 655 may generate a first token, and the generation mechanism 655 may apply the generated token as an input during a second pass. The process may repeat in a loop, successively generating and adding tokens (e.g., words) to the output from the preceding pass and applying the token embeddings of the composite sequence with positional encodings as an input to the decoder(s) 645 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 635, except that it creates its queries from the layer below it and takes the keys and values (e.g., matrix) from the output of the encoder(s) 635.

As such, the decoder(s) 645 may output some decoded (e.g., vector) representation of the input being applied during a particular pass. The classifier 650 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 655 may select or sample a word or token based on a corresponding predicted probability (e.g., select the word with the highest predicted probability) and append it to the output from a previous pass, generating each word or token sequentially. The generation mechanism 655 may repeat the process, triggering successive decoder inputs and corresponding predictions until selecting or sampling a symbol or token that represents the end of the response, at which point, the generation mechanism 655 may output the generated response.

FIG. 6C is a block diagram of an example implementation in which the generative LM 630 includes a decoder-only transformer architecture. For example, the decoder(s) 660 of FIG. 6C may operate similarly as the decoder(s) 645 of FIG. 6B except each of the decoder(s) 660 of FIG. 6C omits the encoder-decoder self-attention layer (since there is no encoder in this implementation). As such, the decoder(s) 660 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 660. As with the decoder(s) 645 of FIG. 6B, each token (e.g., word) may flow through a separate path in the decoder(s) 660, and the decoder(s) 660, a classifier 665, and a generation mechanism 670 may use auto-regression to sequentially generate one token at a time until predicting a symbol or token that represents the end of the response. The classifier 665 and the generation mechanism 670 may operate similarly as the classifier 650 and the generation mechanism 655 of FIG. 6B, with the generation mechanism 670 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 7 is a block diagram of an example computing device(s) 700 suitable for use in implementing some embodiments of the present disclosure. Computing device 700 may include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s)), and one or more logic units 720. In at least one embodiment, the computing device(s) 700 may comprise one or more virtual machines (VMs), and/or any of the components thereof may comprise virtual components (e.g., virtual hardware components). For non-limiting examples, one or more of the GPUs 708 may comprise one or more vGPUs, one or more of the CPUs 706 may comprise one or more vCPUs, and/or one or more of the logic units 720 may comprise one or more virtual logic units. As such, a computing device(s) 700 may include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some embodiments, a presentation component 718, such as a display device, may be considered an I/O component 714 (e.g., if the display is a touch screen). As another example, the CPUs 706 and/or GPUs 708 may include memory (e.g., the memory 704 may be representative of a storage device in addition to the memory of the GPUs 708, the CPUs 706, and/or other components). As such, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 may represent one or more links or busses, such as an address bus, a data bus, a control bus, or a combination thereof. The interconnect system 702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 706 may be directly connected to the memory 704. Further, the CPU 706 may be directly connected to the GPU 708. Where there is direct, or point-to-point connection between components, the interconnect system 702 may include a PCIe link to carry out the connection. In these examples, a PCI bus need not be included in the computing device 700.

The memory 704 may include any of a variety of computer-readable media. The computer-readable media may be any available media that may be accessed by the computing device 700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 704 may store computer-readable instructions (e.g., that represent a program(s) and/or a program element(s), such as an operating system). Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 700. As used herein, computer storage media does not comprise signals per se.

The computer storage media may embody computer-readable instructions, data structures, program modules, and/or other data types in a modulated data signal, such as a carrier wave or other transport mechanism, and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 706 may be configured to execute at least some of the computer-readable instructions to control one or more components of the computing device 700 to perform one or more of the methods and/or processes described herein. The CPU(s) 706 may each include one or more cores (e.g., one, two, four, eight, twenty-eight, seventy-two, etc.) that are capable of handling a multitude of software threads simultaneously. The CPU(s) 706 may include any type of processor, and may include different types of processors depending on the type of computing device 700 implemented (e.g., processors with fewer cores for mobile devices and processors with more cores for servers). For example, depending on the type of computing device 700, the processor may be an Advanced RISC Machines (ARM) processor implemented using Reduced Instruction Set Computing (RISC) or an x86 processor implemented using Complex Instruction Set Computing (CISC). The computing device 700 may include one or more CPUs 706 in addition to one or more microprocessors or supplementary co-processors, such as math co-processors.

In addition to or alternatively from the CPU(s) 706, the GPU(s) 708 may be configured to execute at least some of the computer-readable instructions to control one or more components of the computing device 700 to perform one or more of the methods and/or processes described herein. One or more of the GPU(s) 708 may be an integrated GPU (e.g., with one or more of the CPU(s) 706 and/or one or more of the GPU(s) 708 may be a discrete GPU). In embodiments, one or more of the GPU(s) 708 may be a coprocessor of one or more of the CPU(s) 706. The GPU(s) 708 may be used by the computing device 700 to render graphics (e.g., 3D graphics) or perform general purpose computations. For example, the GPU(s) 708 may be used for General-Purpose computing on GPUs (GPGPU). The GPU(s) 708 may include hundreds or thousands of cores that are capable of handling hundreds or thousands of software threads simultaneously. The GPU(s) 708 may generate pixel data for output images in response to rendering commands (e.g., rendering commands from the CPU(s) 706 received via a host interface). The GPU(s) 708 may include graphics memory, such as display memory, for storing pixel data or any other suitable data, such as GPGPU data. The display memory may be included as part of the memory 704. The GPU(s) 708 may include two or more GPUs operating in parallel (e.g., via a link). The link may directly connect the GPUs (e.g., using NVLINK) or may connect the GPUs through a switch (e.g., using NVSwitch). When combined together, each GPU 708 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 706 and/or the GPU(s) 708, the logic unit(s) 720 may be configured to execute at least some of the computer-readable instructions to control one or more components of the computing device 700 to perform one or more of the methods and/or processes described herein. In embodiments, the CPU(s) 706, the GPU(s) 708, and/or the logic unit(s) 720 may discretely or jointly perform any combination of the methods, processes, and/or portions thereof. One or more of the logic units 720 may be part of and/or integrated in one or more of the CPU(s) 706 and/or the GPU(s) 708 and/or one or more of the logic units 720 may be discrete components or otherwise external to the CPU(s) 706 and/or the GPU(s) 708. In embodiments, one or more of the logic units 720 may be a coprocessor of one or more of the CPU(s) 706 and/or one or more of the GPU(s) 708.

Examples of the logic unit(s) 720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 may include one or more receivers, transmitters, and/or transceivers that allow the computing device 700 to communicate with other computing devices via an electronic communication network, including wired and/or wireless communications. The communication interface 710 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 720 and/or communication interface 710 may include one or more data processing units (DPUs) to transmit data received over a network and/or through interconnect system 702 directly to (e.g., a memory of) one or more GPU(s) 708.

The I/O ports 712 may allow the computing device 700 to be logically coupled to other devices, including the I/O components 714, the presentation component(s) 718, and/or other components, some of which may be built in to (e.g., integrated in) the computing device 700. Illustrative I/O components 714 include a microphone, mouse, keyboard, joystick, game pad, game controller, satellite dish, scanner, printer, wireless device, etc. The I/O components 714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 700. The computing device 700 may include depth cameras, such as stereoscopic camera systems, infrared camera systems, RGB camera systems, touchscreen technology, and combinations of these, for gesture detection and recognition. Additionally, the computing device 700 may include accelerometers or gyroscopes (e.g., as part of an inertia measurement unit (IMU)) that allow detection of motion. In some examples, the output of the accelerometers or gyroscopes may be used by the computing device 700 to render immersive augmented reality or virtual reality.

The power supply 716 may include a hard-wired power supply, a battery power supply, or a combination thereof. The power supply 716 may provide power to the computing device 700 to allow the components of the computing device 700 to operate.

The presentation component(s) 718 may include a display (e.g., a monitor, a touch screen, a television screen, a heads-up-display (HUD), other display types, or a combination thereof), speakers, and/or other presentation components. The presentation component(s) 718 may receive data from other components (e.g., the GPU(s) 708, the CPU(s) 706, DPUs, etc.), and output the data (e.g., as an image, video, sound, etc.).

### Example Data Center

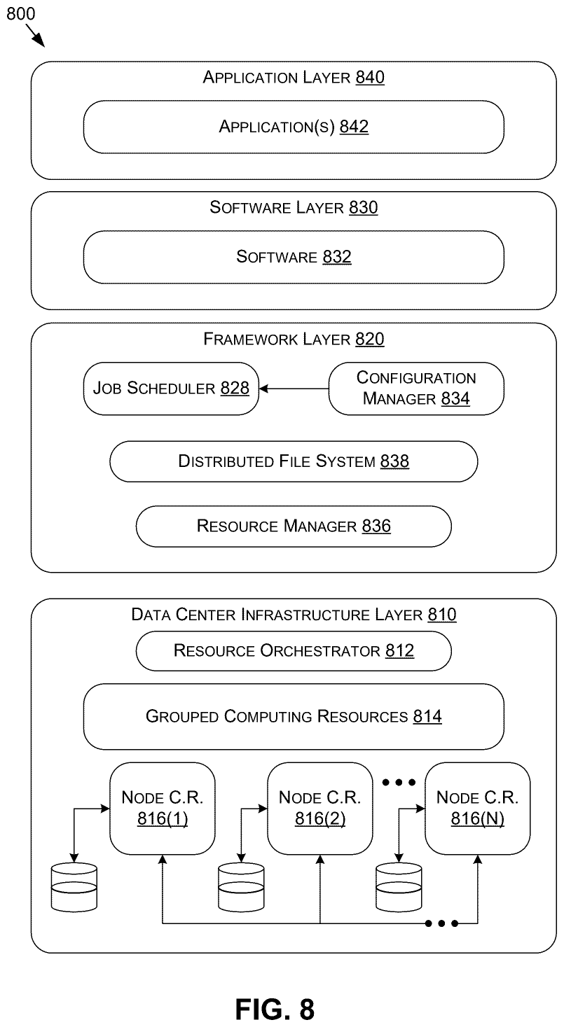

FIG. 8 illustrates an example data center 800 that may be used in at least one embodiments of the present disclosure. The data center 800 may include a data center infrastructure layer 810, a framework layer 820, a software layer 830, and/or an application layer 840.

As shown in FIG. 8, the data center infrastructure layer 810 may include a resource orchestrator 812, grouped computing resources 814, and node computing resources (“node C.R.s”) 816(1)-816(N), where “N” represents any whole, positive integer. In at least one embodiment, node C.R. s 816(1)-816(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 816(1)-816(N) may correspond to a server having one or more of the above-mentioned computing resources. In addition, in some embodiments, the node C.R.s 816(1)-8161(N) may include one or more virtual components, such as vGPUs, vCPUs, and/or the like, and/or one or more of the node C.R.s 816(1)-816(N) may correspond to a virtual machine (VM).

In at least one embodiment, grouped computing resources 814 may include separate groupings of node C.R.s 816 housed within one or more racks (not shown), or many racks housed in data centers at various geographical locations (also not shown). Separate groupings of node C.R.s 816 within grouped computing resources 814 may include grouped compute, network, memory or storage resources that may be configured or allocated to support one or more workloads. In at least one embodiment, several node C.R.s 816, including CPUs, GPUS, DPUs, and/or other processors, may be grouped within one or more racks to provide compute resources to support one or more workloads. The one or more racks may also include any number of power modules, cooling modules, and/or network switches, in any combination.

The resource orchestrator 812 may configure or otherwise control one or more node C.R.s 816(1)-816(N) and/or grouped computing resources 814. In at least one embodiment, resource orchestrator 812 may include a software design infrastructure (SDI) management entity for the data center 800. The resource orchestrator 812 may include hardware, software, or some combination thereof.

In at least one embodiment, as shown in FIG. 8, framework layer 820 may include a job scheduler 828, a configuration manager 834, a resource manager 836, and/or a distributed file system 838. The framework layer 820 may include a framework to support software 832 of software layer 830 and/or one or more application(s) 842 of application layer 840. The software 832 or application(s) 842 may respectively include web-based service software or applications, such as those provided by Amazon Web Services, Google Cloud and Microsoft Azure. The framework layer 820 may be, but is not limited to, a type of free and open-source software web application framework such as Apache Spark™ (hereinafter “Spark”) that may use distributed file system 838 for large-scale data processing (e.g., “big data”). In at least one embodiment, job scheduler 828 may include a Spark driver to facilitate scheduling of workloads supported by various layers of data center 800. The configuration manager 834 may be capable of configuring different layers such as software layer 830 and framework layer 820 including Spark and distributed file system 838 for supporting large-scale data processing. The resource manager 836 may be capable of managing clustered or grouped computing resources mapped to or allocated for support of distributed file system 838 and job scheduler 828. In at least one embodiment, clustered or grouped computing resources may include grouped computing resource 814 at data center infrastructure layer 810. The resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. One or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 834, resource manager 836, and resource orchestrator 812 may implement any number and type of self-modifying actions based on any amount and type of data acquired in any technically feasible fashion. Self-modifying actions may relieve a data center operator of data center 800 from making possibly bad configuration decisions and possibly avoiding underutilized and/or poor performing portions of a data center.

The data center 800 may include tools, services, software, or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 800. In at least one embodiment, trained or deployed machine learning models corresponding to one or more neural networks may be used to infer or predict information using resources described above with respect to the data center 800 by using weight parameters calculated through one or more training techniques, such as, but not limited to, those described herein.

In at least one embodiment, the data center 800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or perform inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 700 of FIG. 7—e .g., each device may include similar components, features, and/or functionality of the computing device(s) 700. In addition, where backend devices (e.g., servers, NAS, etc.) are implemented, the backend devices may be included as part of a data center 800, an example of which is described in more detail herein with respect to FIG. 8.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 700 described herein with respect to FIG. 7. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

Other variations are within spirit of present disclosure. Thus, while disclosed techniques are susceptible to various modifications and alternative constructions, certain illustrated embodiments thereof are shown in drawings and have been described herein in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium stores instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation, such as addition, subtraction, or multiplication. In at least one embodiment, an arithmetic logic unit is used to implement logical operations, such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways, such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

### Example Clauses

Implementation details of various embodiments of the present disclosure are described in the following numbered clauses:

1. In some embodiments, a method comprises receiving a data set including a plurality of interactions with a language model, each interaction of the plurality of interactions being associated with a predefined safety label included in a taxonomy; updating the plurality of interactions based on one or more annotation labels provided for the plurality of interactions, wherein at least one of the annotation labels is absent from the taxonomy; modifying the taxonomy to include the at least one of the annotation labels; generating, using an ensemble of generative machine learning models, one or more machine-defined safety labels for each interaction in the plurality of interactions; generating a training data set based on revising a label associated with each interaction of the plurality of interactions, the revising being based on a majority vote of the one or more machine-defined safety labels and the predefined safety label associated with each interaction of the plurality of interactions, and the one or more annotation labels provided for the plurality of interactions; and updating the language model based on the training data set, wherein the updating implements guardrails on one or more of an input prompt or an output of the language model such that the language model is restricted from generating responses including unsafe content.

2. The method of clause 1, wherein the predefined safety label comprises one of a label indicating that an interaction is safe, a label associated with one of a plurality of unsafe categories, or an ambiguous safety label.

3. The method of clause 2, wherein the plurality of unsafe categories comprises one or more categories not included in a predefined set of unsafe categories.

4. The method of any of clauses 2 or 3, wherein the guardrails on the output of the language model further restrict the language model from generating responses including content that is associated with the ambiguous safety label.

5. The method of any of clauses 1 through 4, wherein each respective interaction of the plurality of interactions comprises a plurality of sub-interactions, and wherein each sub-interaction is associated with a respective predefined safety label.

6. The method of clause 5, wherein a first sub-interaction comprises a prompt and a second sub-interaction comprises a response to the prompt.

7. The method of clause 6, wherein receiving the label associated with the respective interaction comprises revising a safety label assigned to the second sub-interaction but not the first sub-interaction.

8. The method of any of clauses 1 through 7, wherein generating the one or more machine-defined safety labels for each interaction in the plurality of interactions comprises, for each respective interaction, generating a binary safety classification and an unsafe category using each generative artificial intelligence model in the ensemble of generative artificial intelligence models.

9. The method of any of clauses 1 through 8, wherein generating the training data set comprises: determining that a predefined safety label associated with an interaction in the plurality of interactions differs from a label identified based on the majority vote of the one or more machine-defined safety labels; and assigning the identified label to the interaction in the training data set.

10. The method of clause 9, further comprising assigning one or more unsafe categories to the interaction based on unsafe categories assigned to the interaction by the one or more generative artificial intelligence models.

11. The method of any of clauses 1 through 10, wherein generating the training data set comprises: determining that a predefined safety label associated with an interaction in the plurality of interactions is identical to a label identified based on the majority vote of the one or more machine-defined safety labels; and copying the interaction from the received data set to the training data set.

12. The method of any of clauses 1 through 11, wherein the language model is trained to classify an input prompt and a response to the input prompt as safe or unsafe and generate a response based on the classification of the input prompt.

13. The method of clause 12, wherein the language model is trained to classify the input prompt and the response to the input prompt based on topic following.

14. The method of any of clauses 1 through 13, wherein training the language model comprises fine-tuning a base language model based on the training data set.

15. A processor-implemented method for training a language model, the method comprising: receiving a data set comprising a plurality of interactions, each interaction associated with a safety label from an initial taxonomy of safety labels; receiving at least one new annotation label for an interaction in the plurality of interactions, wherein the at least one new annotation label is not present in the initial taxonomy; modifying the initial taxonomy to include the at least one new annotation label, thereby creating a modified taxonomy; and training the language model using the plurality of interactions and the modified taxonomy to implement one or more safety guardrails.

16. The method of clause 15, wherein the safety label comprises one of a label indicating that an interaction is safe, a label associated with one of a plurality of unsafe categories, or an ambiguous safety label.

17. The method of clause 16, wherein the plurality of unsafe categories comprises one or more categories not included in a predefined set of unsafe categories.

18. The method of any of clauses 15 through 17, wherein the language model is trained to implement guardrails on one or more of an input prompt or an output of the language model such that the language model is restricted from generating responses including unsafe content.

19. The method of clause 18, wherein the guardrails on the output of the language model further restrict the language model from generating responses including content that is associated with an ambiguous safety label in the modified taxonomy.

20. The method of any of clauses 15 through 19, wherein each interaction in the plurality of interactions comprises a plurality of sub-interactions, and wherein each sub-interaction is associated with a respective safety label from the modified taxonomy.

21. The method of clause 20, wherein a first sub-interaction comprises a prompt and a second sub-interaction comprises a response to the prompt.

22. The method of any of clauses 15 through 21, further comprising generating the at least one new annotation label based on a binary safety classification and an unsafe category using one or more generative artificial intelligence models in an ensemble of generative artificial intelligence models.

23. A processor-implemented method for providing safety alignment for a generative artificial intelligence model, the method comprising: receiving an input prompt intended for the generative artificial intelligence model; accessing a runtime safety taxonomy that defines one or more safety categories; classifying, using a trained safety model, a safety value associated with the input prompt based at least on the runtime safety taxonomy; and 1) in response to classifying the input prompt above a safety threshold, providing the input prompt to the generative artificial intelligence model to generate an output; or 2) in response to classifying the input prompt below a safety threshold, generating a refusal response without providing the input prompt to the generative artificial intelligence model.

24. The method of clause 23, wherein the runtime safety taxonomy comprises a label indicating that an interaction is safe, a plurality of labels associated with a plurality of unsafe categories, or an ambiguous safety label.

25. The method of clause 24, wherein the plurality of labels associated with the plurality of unsafe categories comprises one or more labels not included in a baseline runtime safety taxonomy including a predefined set of unsafe categories.

26. The method of any of clauses 24 or 25, wherein the safety threshold is configured such that the refusal response is generated for content associated with the ambiguous safety label.

27. The method of any of clauses 23 through 26, further comprising: classifying, using the trained safety model, a safety value associated with the output based at least on the runtime safety taxonomy; and 1) in response to classifying the output above the safety threshold, providing the output to a requesting device, or 2) in response to classifying the output below the safety threshold, generating another refusal response without providing the output to the requesting device.

28. The method of any of clauses 23 through 27, wherein the trained safety model is trained to classify at least the input prompt based on topic following.

29. A processing system, comprising: at least one memory having executable instructions stored thereon; and one or more processors configured to execute the operations of any of clauses 1 through 28.

30. A processing system, comprising means for performing the operations of any of clauses 1 through 28.

31. A non-transitory computer readable medium having executable instructions stored thereon which, when executed by one or more processors, performs the operations of any of clauses 1 through 28.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A processor-implemented method, comprising:
receiving a data set including a plurality of interactions with a language model, each interaction of the plurality of interactions being associated with a predefined safety label included in a taxonomy;
updating the plurality of interactions based on one or more annotation labels provided for the plurality of interactions, wherein at least one of the annotation labels is absent from the taxonomy;
modifying the taxonomy to include the at least one of the annotation labels;
generating, using an ensemble of generative machine learning models, one or more machine-defined safety labels for each interaction in the plurality of interactions;
generating a training data set based on revising a label associated with each interaction of the plurality of interactions, the revising being based on a majority vote of the one or more machine-defined safety labels, the predefined safety label associated with each interaction of the plurality of interactions, and the one or more annotation labels provided for the plurality of interactions; and
updating the language model based on the training data set, wherein the updating implements guardrails on one or more of a user prompt or an output of the language model such that the language model is restricted from generating responses including unsafe content.

2. The method of claim 1, wherein the predefined safety label comprises one of a label indicating that an interaction is safe, a label associated with one of a plurality of unsafe categories, or an ambiguous safety label.

3. The method of claim 2, wherein the plurality of unsafe categories comprises one or more categories not included in a predefined set of unsafe categories.

4. The method of claim 2, wherein the guardrails on the output of the language model further restrict the language model from generating responses including content that is associated with the ambiguous safety label.

5. The method of claim 1, wherein each respective interaction of the plurality of interactions comprises a plurality of sub-interactions, and wherein each sub-interaction is associated with a respective predefined safety label.

6. The method of claim 5, wherein a first sub-interaction comprises a prompt and a second sub-interaction comprises a response to the prompt.

7. The method of claim 6, wherein receiving the label associated with the respective interaction comprises revising a safety label assigned to the second sub-interaction but not the first sub-interaction.

8. The method of claim 1, wherein generating the one or more machine-defined safety labels for each interaction in the plurality of interactions comprises, for each respective interaction, generating a binary safety classification and an unsafe category using each generative artificial intelligence model in the ensemble of generative artificial intelligence models.

9. The method of claim 1, wherein generating the training data set comprises:
determining that a predefined safety label associated with an interaction in the plurality of interactions differs from a label identified based on the majority vote of the one or more machine-defined safety labels; and
assigning the identified label to the interaction in the training data set.

10. The method of claim 9, further comprising assigning one or more unsafe categories to the interaction based on unsafe categories assigned to the interaction by the one or more generative artificial intelligence models.

11. The method of claim 1, wherein generating the training data set comprises:
determining that a predefined safety label associated with an interaction in the plurality of interactions is identical to a label identified based on the majority vote of the one or more machine-defined safety labels; and
copying the interaction from the received data set to the training data set.

12. The method of claim 1, wherein the language model is trained to classify an input prompt and a response to the input prompt as safe or unsafe and generate a response based on the classification of the input prompt.

13. The method of claim 12, wherein the language model is trained to classify the input prompt and the response to the input prompt as safe or unsafe based on topic following.

14. The method of claim 1, wherein training the language model comprises fine-tuning a base language model based on the training data set.

15. The method of claim 1, wherein the at least one of the annotation labels comprises a full set of annotation labels absent from the taxonomy.

16. A system, comprising:
at least one memory having executable instructions stored thereon; and
one or more processors configured to execute the executable instructions to cause the system to:
receive a data set including a plurality of interactions with a language model, each interaction of the plurality of interactions being associated with a predefined safety label included in a taxonomy;
update the plurality of interactions based on one or more annotation labels provided for the plurality of interactions, wherein at least one of the annotation labels is absent from the taxonomy;
modify the taxonomy to include the at least one of the annotation labels;
generate, using an ensemble of generative machine learning models, one or more machine-defined safety labels for each interaction in the plurality of interactions;
generate a training data set based on revising a label associated with each interaction of the plurality of interactions, the revising being based on a majority vote of the one or more machine-defined safety labels, the predefined safety label associated with each interaction of the plurality of interactions, and the one or more annotation labels provided for the plurality of interactions; and
update the language model based on the training data set, wherein the updating implements guardrails on one or more of a user prompt or an output of the language model such that the language model is restricted from generating responses including unsafe content.

17. The system of claim 16, wherein the system is comprised in at least one of:
a system for performing simulation operations;
a system for performing digital twin operations;
a system for performing collaborative content creation for 3D assets;
a system for performing one or more deep learning operations;
a system implemented using an edge device;
a system for generating or presenting at least one of virtual reality content, augmented reality content, or mixed reality content;
a system implemented using a robot;
a system for performing one or more conversational AI operations;
a system implemented using one or more large language models (LLMs);
a system implemented using one or more small language models (SLMs);
a system implementing one or more vision language models (VLMs);
a system implementing one or more multi modal language models;
a system for generating synthetic data;
a system for performing one or more generative AI operations;
a system incorporating one or more virtual machines (VMs);
a system implemented at least partially in a data center; or
a system implemented at least partially using cloud computing resources.

18. A processor-implemented method for generating a training data set, the method comprising:
receiving a data set comprising a plurality of interactions, each interaction of the plurality of interactions associated with a predefined safety label;
for an interaction of the plurality of interactions, generating a plurality of machine-defined safety labels using a corresponding plurality of machine learning models in an ensemble;
revising the predefined safety label associated with the interaction based on a majority vote of the plurality of machine-defined safety labels, thereby creating a revised interaction; and
generating a training data set for a language model, the training data set comprising the revised interaction.

19. The method of claim 18, wherein generating the plurality of machine-defined safety labels for each interaction in the plurality of interactions comprises, for each respective interaction, generating a binary safety classification and an unsafe category using each generative artificial intelligence model in the ensemble of generative artificial intelligence models.

20. The method of claim 18, wherein each interaction in the plurality of interactions comprises a prompt and a response to the prompt, and wherein the prompt is associated with a first plurality of machine-defined safety labels and the response to the prompt is associated with a second plurality of machine-defined safety labels.
